(19) United States
(12) Patent Application Publication
(10) Pub. No.: US 2012/0060133 A1
(43) Pub. Date: Mar. 8, 2012

(54) Annotation of RTL to Simplify Timing Analysis

(76) Inventor: Manjeri R. Krishnan, Richardson, TX (US)

(21) Appl. No.: 12/876,659

(22) Filed: Sep. 7, 2010

(51) Int. Cl. G06F 17/50; G06F 9/455

(52) U.S. Cl. 716/108

(57) ABSTRACT

A method for simulating operation of a design model for a digital system is provided. A library of functional cells is maintained in a storage unit that includes an attribute template with one or more of the functional cells in the library. The attribute template provides fields for specifying design constraint data for a functional cell each time it is instantiated in a design model. A design model is created and stored that includes one or more instantiations of a functional cell and its associated design constraint data. A set of test cases may be pruned to remove test cases that are not needed based on the design constraint data associated with the instantiated functional cells of the design model.

### FIELD OF THE INVENTION

This invention generally relates to design tools for static timing analysis of integrated circuit designs, and in particular to annotation of register transfer logic (RTL) code to capture design knowledge.

### BACKGROUND OF THE INVENTION

Application specific integrated circuits (ASIC) are routinely developed in order to reduce product costs or to increase product functionality. Design verification of complex digital devices has developed rapidly as a technical discipline to keep pace with the immense progress in design methodology. As such, design verification addresses various facets of the efforts required to develop an ASIC. Once the functional specification is defined, a register transfer logic (RTL) model is developed and then a gate level implementation is produced.

The design verification task may include various steps listed below:
Functional verification of the implementation against the specification which verifies both the architectural and implementation specific device requirements;
Performance verification which evaluates the cycle count involved in multiple clock sequences against optimal performance;
Test plan design and test specification design: creation of stimulus/test cases;
Formal model checking and state machine analysis;
Creation of test coverage models; and
Bug tracking and reporting.

The RTL model is used to drive a random test case generation process. Control files are developed by an engineer to direct the flow of the random test generation. The output of the random test generation is a large number of test cases, typically thousands. These test cases exercise the device under test in an extensive manner that could not be addressed by manual generation and the result is that adherence to many functional requirements is quickly explored. The RTL simulation uses these extensive test cases to produce the simulation result that may then be processed by a change detector. If the many thousands of random test cases are effective and score hits on prevailing bugs, many thousands of failures are generated. This kind of shot gun approach to revealing and identifying bugs in the design is indispensable in progressing in a timely fashion toward a bug-free design.

A timing Path (TP) is a serial connection of logic elements or cells. An input is made to the TP, and the computation is made as the signal propagates through the TP. The TP delay is of interest in designing a chip: This determines the speed of the chip. The TP delay is the sum of cell delays. Traditional static timing analysis (STA) is, and has been, the method that virtually every digital design team uses to achieve timing signoff. In STA, a timing model is required for every cell in the design, or at least for the signal paths that are analyzed. The analyzer uses those timing models to calculate delays for all cells in a given path. Those delays, in turn, are summed to determine total path delays.

Once a design has been solidified, an initial layout of the design may be done and then analyzed. Timing delays determined from the layout may then be back annotated into the RTL code for use in RTL simulation to better predict actual timing performance of the timing paths within the ASIC.

### BRIEF DESCRIPTION OF THE DRAWINGS

Particular embodiments in accordance with the invention will now be described, by way of example only, and with reference to the accompanying drawings:

FIG. 1 is a block diagram of a design system for designing integrated circuits in accordance with an embodiment of the present invention;

FIG. 2 is a flow chart illustrating capture of design constraint data in RTL code of a ASIC design; and

FIG. 3 is a block diagram of a typical design system that includes an embodiment of the present invention.

### DETAILED DESCRIPTION OF EMBODIMENTS OF THE INVENTION

As improvements in integrated circuit (IC) technology allow designs of application specific integrated circuits (ASIC) to become more complicated and now allow an entire system on a chip (SOC) to be designed and implemented, the design verification process becomes correspondingly more complicated. In many systems, there are timing paths that exist in the design, but that will never be a used or will not be a critical factor in the actual operation of the system. However, the STA will still test every path in the design that does not have a timing exception applied to it and time will be wasted testing and even optimizing these non-critical timing paths.

Embodiments of the invention provide a way to capture design constraint information about the intended operation of the system that the designer is aware of and to provide this information to the STA system as exceptions to particular timing paths so that the STA system knows to treat the timing paths accordingly. The design verification effort for a complex integrated circuit may be addressed by at least tens if not over a hundred engineers and requires a high degree of coordination and mutual support if it is to be accomplished efficiently

Embodiments of the invention provide a method for simulating operation of a design model for a digital system that takes advantage of design constraints. An attribute template is included with one or more of the functional cells in a design library that is used to design an ASIC. The attribute template provides fields for specifying design constraint data for a functional cell each time it is instantiated in a design model. As a designer or design team creates the system design, the various library cells are instantiated to implement the design. The designer(s) may then enter design constraint data into the template for a particular instantiation of a functional cell and then store the design model.

Once the design model is completed, the STA determines all of the timing paths. The set of timing paths is pruned to remove test cases that are not needed based on the design constraint data associated with the instantiated functional cells of the design model. A static timing analysis of the design model may then be done using the pruned set of timing paths. In this manner, knowledge from the design(s) may be encapsulated with the design model and used to simplify system testing.

Embodiments of this invention are not limited to any particular model language, nor are they limited to the type of target model. Register transfer language (RTL) models or other functional models are equally applicable. RTL code may be written in any suitable hardware description language such as, for example, Verilog complying with IEEE 1364 or VHDL (Very High Speed Integrated Circuit Hardware Description Language) complying with IEEE 1076, for example.

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

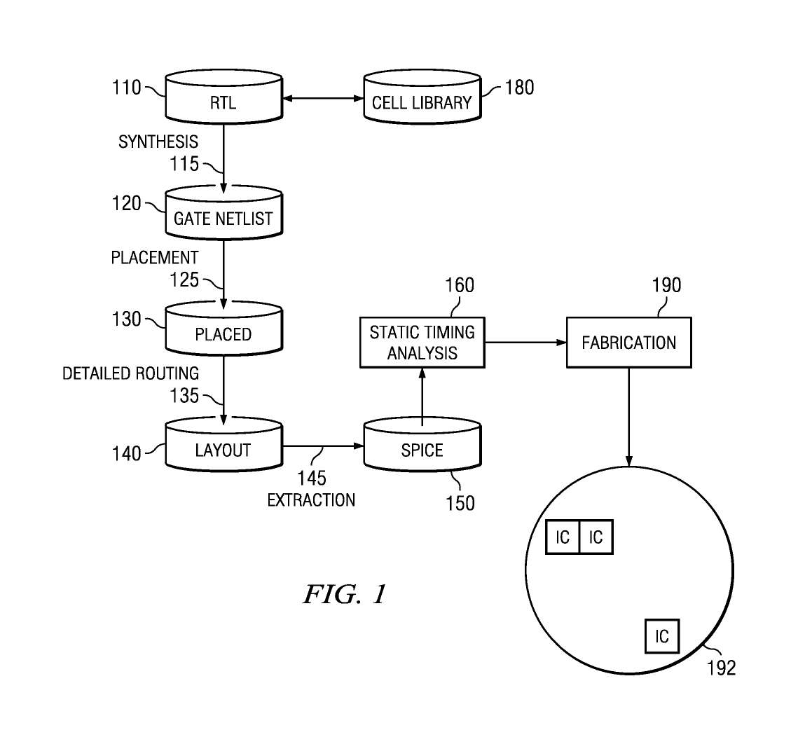

FIG. 1 is a block diagram of a design system for designing an ASIC in accordance with an embodiment of the present invention. The specification of a circuit exists at multiple levels. RTL model 110 is the specification of a circuit design at the register transfer level. It can be written by hand, or can be generated by other design tools. A cell is an abstract representation of a component in a design. Cell library 180 contains a set of cells that define various functional blocks that can be instantiated multiple times to form an RTL circuit design. Cell library 180 is a collection of descriptors of the physical layouts of the component or multiple components that form a respective electrical device or devices, where each layout is referred to as a cell or standard cell. Thus, for each component, such as one more individual circuit elements, logical functions, or storage elements, one or more cells are included in cell library 180 to designate a corresponding one or more physical layout of the layers used in integrated circuit construction to implement the component. The RTL specification defines how the instantiated functional blocks are interconnected to produce the complete circuit design for the ASIC.

A synthesis tool 115 is a program that is used to convert the RTL specification of a circuit into a gate netlist 120. Netlist 120 represents a description of devices as defined by their nodes and the functionality of each device as between their nodes, where such devices may include any circuit element including transistors, resistors, capacitors, and so forth. Netlist 120 includes the connections between these devices as well as their terminals, or “ports,” to the external environment.

Another program, the placement tool 125, is used to convert a gate netlist representation of a circuit design into placed gates 130. Finally a detailed routing program 135 is used to generate an exact layout 140 of the circuit design. Typically, an electronic design automation (EDA) tool performs both placement and routing. Placement in this context refers to the assignment of a location for each component in netlist 120, as guided by certain rules that accompany the placement determination. In other words, placement program 125, when executed by a processing system, defines a two-dimensional area that corresponds to the area the ASIC to be constructed, and then determines the location within that area for each component in netlist 120 so that the determined placement is according to, and does not violate, the accompanying placement rules.

After a layout has been generated, timing analysis consists of running an extraction program 145 to extract a Spice 150 representation of the design. Then, static timing analysis tool 160 is used to generate timing results for the circuit. One or more steps in the standard flow may be combined into a single software package. One example of a static timing analysis tool is the tool sold by Synopsys, Inc, under the trademark PrimeTime. Once timing results are produced, hand-optimization is used to change circuit specifications at the RTL level. Optimizations at other levels may be difficult and time consuming to incorporate.

Once all simulation and testing is completed, images are formed on respective reticules so that each circuit layer may be formed on a wafer using known semiconductor fabrication processing 190, to form a wafer 192 that is separated into multiple die (IC) that each correspond to the ASIC. Each die is then packaged and tested.

The general operation of design process of FIG. 1 is well known in the art and also should be understood with reference to the descriptions above. The EDA system may be any suitable collection of software tools that provides computer-aided design of ICs. Suitable EDA systems are available from, for example, Magma Design Automation, Inc. (Santa Clara, Calif.), Cadence Design Systems, Inc. (San Jose, Calif.), and Mentor Graphics (Wilsonville, Oreg.).

As will be described in more detail below, in various embodiments of the invention, some types of the functional blocks in cell library 180 include a template that the designer of the ASIC can fill in each time that type of functional block is instantiated in the RTL model. This allows design constraints for that particular instantiation of a functional block to be encapsulated in the RTL model. For example, templates to capture design constraints may be provided for registers, multiplexors, clock-gates, input/output (I/O) pins, etc.

For example, a multiplexor cell may be used to select two or more clock rates. The designer knows that the select input to the multiplexor will only be changed when an operating mode of the system is changed; therefore there is no need to perform timing analysis on the select input for this particular instantiation of the multiplexor cell. Similarly, the select signal may be pseudo-static and change only as a result of the system being in test mode, or in a particular JTAG state, or in a configuration state, etc. In these cases, rigorous timing analysis does not need to be performed on the select input signals. There may be other special timing requirements known to the designer.

Since a multiplexor is a candidate for design constraints, a template may be provided by the EDA system each time a multiplexor is instantiated to capture these design constraints. The design constraint data for each instantiation of a candidate cell is then embedded with the RTL code for later use by the test generation process. Table 1 provides an example of RTL code for a multiplexor along with design constraint data that may be captured by a template and embedded in the RTL code. In this example for multiplexor instantiation “pbist_clk_int_mux_{—}1”, the captured design constraint data indicates the multiplexor is a clock multiplexor that has a pseudo-static select signal. Therefore, the STA system may now use this information to place exceptions on timing paths that toggle the select signal to this multiplexor.

TABLE 1
RTL for a multiplexor with embedded design constraint data

RTL pbist_lib/pbist_clk/vhdl/synth.vhd:
----------------------------------------------------------------------------------------------------------
-- 2 Input Clocks

| | |
|---|---|
| pbist_clock_mux_gen_2: IF ( NO_OF_CLOCKS = 2 ) | GENERATE |
| pbist_clk_int_mux_1: pbist_ti_clk_mx2 PORT MAP | ( |
| | s => phist_clk_mux_sel(0), |
| | a => pbist_clk_int_0(0), |
| | b => pbist_clk_int_0(1), |
| | y => pbist_clk_int_1(0) |

);

clk_pbist_out <= phist_clk_int_1(0);
END GENERATE pbist_clock_mux_gen_2;
----------------------------------------------------------------------------------------------------------
Clock Mux in gate-level netlist:
Icurie_dftss/I_pbist_108/pbist_clk0/pbist_clk_int_mux_1/ti_clk_mx2_39/ti_clk_mux20
----------------------------------------------------------------------------------------------------------
Template for Multiplexor:

| | |
|---|---|
| 1. | Mux Pattern: “*pbist_clk_int_mux_1*” |
| 2. | Is this a clock mux? Yes |
| 3. | Is the select signal pseudo-static (changes only as a result of |
| | Test mode, JTAG state, VBUS/CFGBUS write, etc.)? Yes |
| 4. | Are there any special timing requirements? No |

----------------------------------------------------------------------------------------------------------

In a similar manner, a template may be provided for a register cell. Design constraints for a register may include the following types of data:

Is the input signal to register stable when latched (set up several cycles ahead)?

Is the output signal from register pseudo-static (changes only as a function of Test mode, JTAG state, VBUS/CFGBUS write, etc.)?

If the register has a prez pin, does the signal need to meet single-cycle timing?

If the register has a clrz pin, does the signal need to meet single-cycle timing?

Is the register scannable for Stuck-At faults?

Is the register scannable for Transition/Delay faults?

Is the register clocked by raw TCK clock in functional mode of operation?

Is the register clocked by an IO clock in functional mode of operation?

Are there any special timing requirements?

Table 2 provides an example of RTL code for a register along with design constraint data that is captured by a template and embedded in the RTL code. In this example for register instantiation “ir_ref_rf”, the captured design constraint data indicates the data signal is known to be stable when latched. Therefore, the STA system may now use this information to set a multi-cycle timing exception on these paths which would effectively relax the timing on paths through these signals since these signals do not need to meet single (default) cycle timing. The design constraint data also indicates the output data is pseudo-static; therefore the automated test system may now use this information to place exceptions on timing paths that include the data output signal to other cells.

TABLE 2
RTL for a register with embedded design constraint data

```
RTL debug_lib/icepick_c/vhdl/icepick_c_ctl_rtl.vhd:
-------------------------------------------------------------------------------------------
-- This process updates the IR on the falling edge of the clock
-------------------------------------------------------------------------------------------
IR_REG_PROC:PROCESS (pictckin_n, icepickregresetn)
  BEGIN
    IF (icepickregresetn = ‘0’) THEN
      ir_reg_rf <= IR_OPC_IDCODE;
    ELSIF (pictckin_n′event AND pictckin_n = ‘1’) THEN
      if (picurrent_state = update_IR) then
      ir_reg_rf <= ir_shift_reg;
    END IF;
  END IF;
END PROCESS IR_REG_PROC;
-------------------------------------------------------------------------------------------
Register in gate-level netlist:
Idebugss/I_dcs_inst/I_icepick_inst/U1_ICEPICK/U7_ICEPICK_CTL/
ir_reg_rf_reg[*]
-------------------------------------------------------------------------------------------
Template for Register:
```

| | |
|---|---|
| 1. | Register Pattern: “*ir_ref_rf*” |
| 2. | Is the input signal to register stable when latched (set up several |
| | cycles ahead)? Yes |
| 3. | Is the output signal from register pseudo-static (changes only as a |
| | function of Test mode, JTAG state, VBUS/CFGBUS write, etc.)? Yes |
| 4. | If the register has a prez pin, does the signal need to meet single- |
| | cycle timing? No |
| 5. | If the register has a clrz pin, does the signal need to meet single- |
| | cycle timing? Yes |
| 6. | Is the register scannable for Stuck-At faults? Yes |
| 7. | Is the register scannable for Transition/Delay faults? Yes |
| 8. | Is the register clocked by raw TCK clock in functional mode of |
| | operation? Yes |
| 9. | Is the register clocked by an IO clock in functional mode of operation? |
| | No |
| 10. | Are there any special timing requirements? No |

-------------------------------------------------------------------------------------------

In a similar manner, a template may be provided for a clock gate cell. Design constraints for a clock gate may include the following types of data:

Does the clock gating check need to be done?

Is the enable signal pseudo-static (changes only as a result of Test mode, JTAG state, VBUS/CFGBUS write, etc.)?

Are there any special timing requirements?

Can the enable signal transition while the clock is running?

Table 3 provides an example of RTL code for a clockgate along with design constraint data that is captured by a template and embedded in the RTL code. In this example for clockgate instantiation “c_cts_stg1_nand4”, the captured design constraint data indicates the clockgate has a pseudo-static enable signal. Therefore, the STA system may now use this information to place exceptions on timing paths that toggle the enable signal to this clockgate.

TABLE 3

| RTL for a clockgate with embedded design constraint data | |
|---|---|
| RTL pll_lib/pll_ctrl/pds/extract/modules/pll_ctrl/hdl/rtl/ | |
| pll_ctrl_obsclk_gen.vhd: | |
| ---------------------------------------------------------------------------------- | |
| obssel_4_n <= not obssel_pi(4) and od1_en_gate; | |
| c_cts_stg1_nand4: ti_clk_na2 | |
| port map ( | |
| a => od1_clkout_pi, | |
| b => obssel_4_n, | |
| y => clk_tap_od1 | |
| ); | |
| ---------------------------------------------------------------------------------- | |
| Clockgate (nand) in gate-level netlist: | |
| Ipll0_ss__Ipll0_ctrl/Ipll_ctrl/i_pll_obsclk_gen/c_cts_stg1_nand4/u0 | |
| ---------------------------------------------------------------------------------- | |
| Template for Clockgate: | |
| 1. | Clockgate Pattern: “*c_cts_stg1_nand4*” |
| 2. | Does the clockgating check need to be done? No |
| 3. | Is the enable signal pseudo-static (changes only as a result of |
| | Test mode, JTAG state, VBUS/CFGBUS write, etc.)? Yes |
| 4. | Are there any special timing requirements? No |

----------------------------------------------------------------------------------

In a similar manner, a template may be provided for a set of I/O pins. Design constraints for an I/O pin may include the following types of data:

1—I/O Pin Pattern: <pattern>

2—Are paths through this I/O pin timed by raw TCK clock in functional mode of operation?

3—Are paths through this I/O pin timed by an IO clock in functional mode of operation?

4—Are paths through this I/O pin pseudo-static (change only as a function of Test mode, JTAG state, VBUS/CFGBUS write, etc)?

5—Do paths through this I/O pin have a constant value in functional mode of operation? If yes, what value? (Yes/No), (1/0)

6—Do paths through this I/O pin have a constant value in TFT-capture mode of operation? (Yes/No), (1/0)

7—Do paths through this I/O pin have a constant value in TFT-shift mode of operation? (Yes/No), (1/0)

8—Do paths through this I/O pin have a constant value in auto test pattern generation (ATPG)-capture mode of operation? (Yes/No), (1/0)

9—Do paths through this I/O pin have a constant value in ATPG-shift mode of operation? (Yes/No), (1/0)

10—Are there any special timing requirements? (Yes/No)

Table 4 provides an example of RTL code for a set of I/O pins along with design constraint data that is captured by a template and embedded in the RTL code. In this example, the constraint data is numbered to match the list above. For I/O pin instantiation “dft_scan_en[*]”, the captured design constraint data indicates the path through this I/O pin is pseudo-static signal, as indicated by “Y” in column 4. Furthermore, column 5 indicates the path through this pin has a constant value of “0” in the functional mode of operation. Therefore, the STA system may now use this information to eliminate timing paths that toggle the data path through this I/O pin and may instead set the signal value to a logic “0” value. Other pins are also listed here with associated constraint data.

Similarly, the STA system may make further assumptions about the signal path in other operating modes as indicated by columns 6-9.

TABLE 4
RTL for a set of I/O pins with embedded design constraint data
Template for Input/Output Pins of dftss module:

| (1) | (2) | (3) | (4) | (5) | (8) | (7) | (8) | (9) | (10) |
|---|---|---|---|---|---|---|---|---|---|
| dft_scan_en[*] | Y | N | Y | Y0 | Y0 | Y1 | Y1 | Y0 | N |
| dft_partition_en[*] | Y | N | Y | Y1 | Y1 | Y1 | Y1 | Y1 | N |
| dft_div_scan_en[*] | Y | N | Y | Y0 | Y0 | Y0 | Y1 | Y0 | N |
| dft_mode_atpg | Y | N | Y | Y0 | Y1 | Y1 | Y1 | Y1 | N |
| dft_mem_atpgm | Y | N | Y | Y0 | Y1 | Y1 | Y1 | Y1 | N |
| dft_p1500nviswrstn | Y | N | Y | Y? | Y1 | Y1 | Y1 | Y1 | N |
| dft_test_async_rst_n | Y | N | Y | Y? | Y1 | Y1 | Y1 | Y1 | N |
| dft_loc_los | Y | N | Y | Y0 | Y0 | Y0 | Y0 | Y0 | N |
| dft_test_clk_sel | Y | N | Y | Y0 | Y1 | Y1 | Y1 | Y1 | N |
| dft_delay_fault_en | Y | N | Y | Y0 | Y1 | Y1 | Y0 | Y0 | N |
| dft_pll_capture_en | Y | N | Y | Y0 | Y1 | Y0 | Y0 | Y0 | N |
| dft_pll_bypass | Y | N | Y | Y0 | Y1 | Y1 | Y1 | Y1 | N |
| dft_bypass_div_en | Y | N | Y | Y0 | Y0 | Y1 | Y1 | Y1 | N |
| dft_clk_force_en | Y | N | Y | Y0 | Y0 | Y0 | Y0 | Y0 | N |
| dft_mode_pll_atpg | Y | N | Y | Y0 | Y0 | Y0 | Y1 | Y1 | N |
| dft_local_clk_en | Y | N | Y | Y0 | Y1 | Y1 | Y1 | Y1 | N |
| dft_rpc_ntch_pad_oe | Y | N | Y | Y? | Y0 | Y? | Y? | Y0 | N |

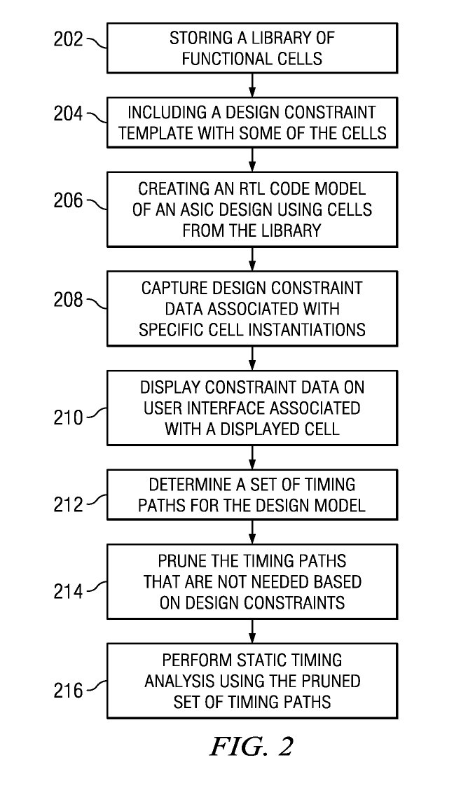

FIG. 2 is a flow chart illustrating operation of an electronic design automation system that captures design constraint data in the RTL code of an ASIC design. As described earlier, a cell library is a set of cells that define various functional blocks that can be instantiated multiple times to form an RTL circuit design. A cell library is stored 202 for use by the EDA tools.

Certain types of the functional blocks in the cell library include 204 a template that the designer of the ASIC can fill in each time that type of functional block is instantiated in the RTL model. This allows design constraints for that particular instantiation of a functional block to be encapsulated in the RTL model. For example, templates to capture design constraints may be provided for registers, multiplexors, clock-gates, input/output (I/O) pins, etc. Various types of cells and associated design constraint data are described in more detail above.

The system is used by one or more designers to create 206 an RTL model of a new ASIC by instantiating various cells from the library and indicating how they are interconnected. The RTL code written by the designer defines how the instantiated functional blocks are interconnected to produce the complete circuit design for the ASIC.

The design system captures 208 design constraint data that the designer(s) may enter into the template for a particular instantiation of a functional cell and then store with the design model.

Each time any designer that is working on the project accesses the RTL, the design constraint data is displayed 210 for each candidate cell along with the RTL code associated with that instantiation of the cell. Some embodiments of the EDA system may allow display of the design constrain data to be suppressed when the designer does not wish to view it in order to display more RTL code.

Once the design model is completed, a set of timing paths is determined 212 for the design model using the STA system. The set of timing paths is pruned 214 to remove timing paths that are not critical based on the design constraint data associated with the instantiated functional cells of the design model. A static timing analysis of the design model may then be done 216 using the pruned set of timing paths. In this manner, knowledge from the design(s) may be encapsulated with the design model and used to simplify system timing analysis.

Capturing design constraint data in the RTL code for an ASIC design provides many benefits and advantages. It enables capturing of timing exception information by RTL designers who are most knowledgeable about associated functionality. It provides an efficient mechanism for documenting timing exceptions and mitigates support issues for timing exceptions development when various modules are produced by different design teams and then combined to form an SOC. Oftentimes, the SOC team does not understand all the details of the various modules, so it helps to get the module designers to enter the constraint information for use by the SOC team

Capturing design constraint data in the RTL code avoids versioning issues, provides a means for continuous improvement and maturity, enables quick and efficient review of timing exceptions. It facilitates easy reuse across chip teams, enables automation, and supports hierarchical development.

It decouples timing exceptions development from clock tree synthesis (CTS) and reduces likelihood of costly errors. Typically, timing exceptions change when clock tree changes since this exposes a different set of timing paths, and STA is largely timing violation driven, that is, a goal is to resolve all paths that violate timing. Embodiments of the invention approach the task of STA and timing exceptions independently of the clock trees involved.

### System Example

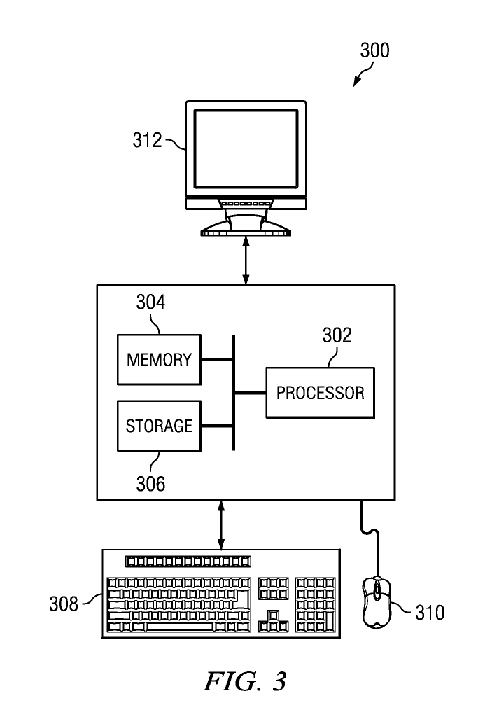

FIG. 3 shows a simplified block diagram of an illustrative computer system (300) that can be used to execute software incorporating embodiments of the invention. The computer system (300 includes a processor (302), associated memory (304), a storage subsystem (306), and numerous other elements and functionalities typical of computer systems (not shown). In one or more embodiments of the invention, the computer system (300) may include multiple processors and some or all of the associated memory (304) may be shared by the multiple processors. The computer system (300) may also include input means, such as a keyboard (308) (or other input device) and a mouse (310) (or other cursor control device), and output means, such as a monitor (312) (or other display device). The computer system (300) may be connected to a network (not shown) (e.g., a local area network (LAN), a wide area network (WAN) such as the Internet, a cellular network, any other similar type of network and/or any combination thereof) via a network interface connection (not shown). Those skilled in the art will appreciate that the input and output means may take other forms. Further, those skilled in the art will appreciate that one or more elements of the computer system (300) may be located at a remote location and connected to the other elements over a network.

The storage subsystem (306) provides storage for program and data files, and may include one or more storage devices such as, for example, a hard disk drive, a floppy disk drive, a CD/DVD drive, and/or an optical drive. Executable software configured to perform embodiments of the invention when executed by the processor (302) may be stored in the storage subsystem (306) along with some or all of the required data.

Software instructions, scripts, files, etc. to perform embodiments of the invention may be stored on a computer readable medium such as a compact disc (CD), a diskette, a tape, a file, memory, or any other computer readable storage device or any combination thereof. The software instructions, scripts, files, etc. may be distributed to the computer system (300) via removable computer readable media (e.g., floppy disk, optical disk, flash memory, USB key), via a transmission path from a computer readable medium on another server, network-attached storage device, etc.

### Other Embodiments

Embodiments of the invention described herein may be implemented by software stored on one or more computer readable storage media and executed on a computer. Additionally, some of the disclosed techniques may be implemented as part of a computer implemented electronic design automation (EDA) system or may interface with an EDA system. The techniques may be executed on a single computer or a computer networked with another computer or computers.

For simplicity of explanation, some embodiments of the invention are described herein in a specific context, namely developing a single integrated circuit. However, one of ordinary skill in the art will understand embodiments of the invention may be used to developer system designs including multiple integrated circuits packaged together, such as in a multi-chip module, a system on a chip, and so forth, into a single electronic device.

In some embodiments, constraint data is entered into the RTL by the designer without a template being provided. In this case, an agreed upon format is used by the designer so that the downstream automated system may recognize the various constraints that are provided by the designer. The implementation could be something as simple as embedding the templates in the RTL code itself via comment lines or something sophisticated like a graphical user interface that enables data entry, review, and management.

While various examples of constraint data for specific types of functional cells are described herein, it should be understood that various embodiments may implement various types and combinations of constraints for various types of functional cells. The constraints described herein are just examples and should not be interpreted as being limiting.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

Certain terms are used throughout the description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope and spirit of the invention.

What is claimed is:

1. A method for simulating operation of a design model for a digital system, the method comprising:
storing a library of functional cells in a storage unit;
including an attribute template with one or more of the functional cells in the library, wherein the attribute template provides fields for specifying design constraint data for a functional cell each time it is instantiated in a design model; and
storing a design model in a storage unit that includes one or more instantiations of a functional cell and its associated design constraint data.

2. The method of claim 1, wherein the functional cells are register transfer logic cells.

3. The method of claim 1, further comprising displaying the design constraint data associated with a first functional cell instantiation when a portion of the design model containing the first functional cell instantiation is displayed by a user interface.

4. The method of claim 1, further comprising:
determining a set of timing paths for the design model;
pruning the set of timing paths to remove timing paths that are not critical based on the design constraint data associated with the instantiated functional cells of the design model; and
producing a static timing analysis of the design model using the pruned set of timing paths.

5. The method of claim 1, wherein the design constraint data identifies a timing path within a functional cell that does not need to be tested for a particular instantiation of the functional cell.

6. A design analysis system for simulating the operation of a design model for a digital system, the timing analysis system comprising:
a timing path module configured to receive a high level language design model for the digital system and to determine a set of timing paths for the design model, wherein the design model includes constraint data associated with a specific cell instantiation in the design model; and
a pruning module configured to analyze the constraint data and to prune the set timing paths to indicate timing paths that are not needed based on the constraint data.

7. The design analysis system of claim 6, further comprising a timing analysis module configured to perform static timing analysis of the design model using the pruned set of timing paths.

8. The design analysis system of claim 6, further comprising a library of functional cells, wherein a design constraint template is included with one or more of the cells.

9. The design analysis system of claim 6, further comprising a user interface module operable to display a constraint template to a user and to gather constraint data from the user when the specific cell is instantiated by the user.

10. The design system of claim 6, wherein the high level language describes a register transfer logic (RTL) design model.

11. An application specific integrated circuit (ASIC) designed by a process, wherein the process comprises:
creating a high level language design model of one or more logic modules within the ASIC by instantiating functional cells from a library of functional cells; and
capturing design constraint data associated with specific functional cell instantiations while the design model is being created.

12. The ASIC of claim 11, wherein the process further comprises:
determining a set of timing paths for the design model;
pruning the set of timing paths to remove timing paths that are not critical based on the design constraint data associated with the instantiated functional cells of the design model; and
producing a static timing analysis of the design model using the pruned set of timing paths.

13. The ASIC of claim 11, wherein the design constraint data identifies a timing path within a functional cell that does not need to be tested for a particular instantiation of the functional cell.

14. The ASIC of claim 11, wherein the design constraint data is captured in a template that is included with the instantiated functional cell.
